(19) United States
(12) Patent Application Publication
(10) Pub. No.: US 2023/0128921 A1
(43) Pub. Date: Apr. 27, 2023

(54) WIRELESS COMMUNICATION METHOD, WIRELESS COMMUNICATION SYSTEM, QUALITY PREDICTION ENGINE, WIRELESS TERMINAL APPARATUS, AND PROGRAM

(71) Applicant: NIPPON TELEGRAPH AND TELEPHONE CORPORATION, Tokyo (JP)

(72) Inventors: Keisuke WAKAO, Musashino-shi, Tokyo (JP); Kenichi KAWAMURA, Musashino-shi, Tokyo (JP); Takatsune MORIYAMA, Musashino-shi, Tokyo (JP); Shota NAKAYAMA, Musashino-shi, Tokyo (JP)

(73) Assignee: NIPPON TELEGRAPH AND TELEPHONE CORPORATION, Tokyo (JP)

(21) Appl. No.: 17/908,155

(22) PCT Filed: Mar. 2, 2020
(86) PCT No.: PCT/JP2020/008707

§ 371 Date: Aug. 30, 2022

(51) Int. Cl. H04W 24/08

(52) U.S. Cl. CPC H04W 24/08

(57) ABSTRACT

A wireless communication method according to an embodiment is a method executed by a wireless terminal apparatus and a quality prediction engine that predicts a quality related to communication performed by the wireless terminal apparatus, and the method includes: by the wireless terminal apparatus, notifying the quality prediction engine of information about a plurality of wireless base stations connectable to the wireless terminal apparatus, model information of the wireless terminal apparatus, information about wireless communication environment around the wireless terminal apparatus, and information detected by a sensor mounted on the wireless terminal apparatus; by the quality prediction engine, calculating, based on the notified information, a predicted value of a communication quality when the wireless terminal apparatus is connected to the plurality of connectable wireless base stations in accordance with a prediction function, and notifying the wireless terminal apparatus of the calculated predicted value; and by the wireless terminal apparatus, selecting a wireless base station to be connected to the wireless terminal apparatus based on the notified predicted value of the communication quality and a communication quality requested by an application program used by the wireless terminal apparatus.

### TECHNICAL FIELD

An embodiment of the present invention relates to a wireless communication method, a wireless communication system, a quality prediction engine, a wireless terminal apparatus, and a program.

### BACKGROUND ART

Studies on a fifth generation mobile communication system (hereinafter referred to as “5G”) as a next-generation mobile communication system have been conducted based on needs and a wide range of application programs (hereinafter referred to as “applications”) using mobile communications. Features of 5G include ultra-high speed, ultra-low latency, and multiple simultaneous connections, and 5G is expected to create new industries and solve social issues.

In order to meet communication quality required for 5G, 5G is formed by a heterogeneous network that utilizes various frequency bands ranging from a low frequency band, such as a 800 MHz band, a 2 GHz band, a sub 6 GHz band, or Wi-Fi, to a high frequency band, such as a millimeter wave band.

In order to effectively utilize the heterogeneous network, multi-wireless network systems represented by simultaneous connection and communication of a cellular phone and Wi-Fi based on 5G dual connectivity or multipath TCP (MPTCP) have been expected to become widespread (see, for example, NPL 1).

Currently, studies on self-employment of such wireless systems has been actively conducted.

Self-employment of wireless systems has been limited to unlicensed band wireless systems including Wi-Fi. However, also in 5G, studies on a self-employed 5G system, a so-called local 5G, which grants licenses to specific land and building owners and users to allow self-employment, have recently been conducted.

As self-employment of wireless systems proceeds, investment in building facilities will become dispersed, and thus it can be expected that a trend of increasing the density of wireless base stations contributing greatly to an increase in the capacity of wireless communication will accelerate significantly.

### CITATION LIST

### Non Patent Literature

NPL 1: O. Semiariet. al., “Integrated Millimeter Wave and Sub-6 GHz Wireless Networks: A Roadmap for Joint Mobile Broadband and Ultra-Reliable Low-Latency Communications,” IEEE Wireless Comm., vol. 26, no. 2, pp. 109-115, 2019 Wi-Fi AP

### SUMMARY OF THE INVENTION

### Technical Problem

On the other hand, increasing the density of wireless base stations makes it difficult to secure a desired communication quality of wireless applications.

As the density of a wireless base station increases, the amount of interference of wireless communication increases, and thus it is expected that the quality of the wireless communication changes in a complicated manner. In particular, in a self-employed wireless system, there is a high possibility that a base station for minimizing the amount of interference between wireless base stations is not likely to be designed, and it is expected that the wireless communication quality will become further complicated.

A wireless terminal of the related art selects a wireless base station having a maximum amount of received power and is communicatively connected to the selected wireless base station. The reason for this is because the above-mentioned selection makes it possible to perform wireless communication at a maximum speed in an environment where there is no interference.

However, in the above-mentioned selection, the quality of a communication path that changes with fluctuation over time in interference traffic of other wireless terminals in a high-density environment of wireless base stations, the number of interference signals, and the intensity of the signals cannot be considered.

In a case where a wireless communication quality decreases below a desired communication quality of a certain wireless application due to this effect, the desired communication quality cannot be secured, and a failure occurs.

The present invention has been contrived in view of the above circumstances, and an object of the present invention is to provide a wireless communication method, a wireless communication system, a quality prediction engine, a wireless terminal apparatus, and a program which make it possible to secure a desired communication quality when a wireless communication apparatus communicates with a wireless base station.

### Means for Solving the Problem

A wireless communication method according to an aspect of the present invention is a method executed by a wireless terminal apparatus and a quality prediction engine that predicts a quality related to communication performed by the wireless terminal apparatus, and the method includes: by the wireless terminal apparatus, notifying, the quality prediction engine of information about a plurality of wireless base stations connectable to the wireless terminal apparatus, model information of the wireless terminal apparatus, information about wireless communication environment around the wireless terminal apparatus, and information detected by a sensor mounted on the wireless terminal apparatus; by the quality prediction engine, calculating a predicted value of a communication quality when the wireless terminal apparatus is connected to the plurality of connectable wireless base stations in accordance with a prediction function obtained through deep learning based on the notified information, and notifying the wireless terminal apparatus of the calculated predicted value; and by the wireless terminal apparatus, selecting a wireless base station to be connected to the wireless terminal apparatus, based on the notified predicted value of the communication quality and a communication quality requested by an application program used by the wireless terminal apparatus.

A wireless communication system according to an aspect of the present invention is a wireless communication system including a wireless terminal apparatus, and a quality prediction engine that predicts a quality related to communication performed by the wireless terminal apparatus, in which the wireless terminal apparatus notifies the quality prediction engine of information about a plurality of wireless base stations connectable to the wireless terminal apparatus, model information of the wireless terminal apparatus, information about wireless communication environment around the wireless terminal apparatus, and information detected by a sensor mounted on the wireless terminal apparatus, the quality prediction engine calculates a predicted value of a communication quality when the wireless terminal apparatus is connected to the plurality of connectable wireless base stations in accordance with a prediction function obtained through deep learning based on the notified information, and notifies the wireless terminal apparatus of the predicted value, and the wireless terminal apparatus selects a wireless base station to be connected to the wireless terminal apparatus, based on the notified predicted value of the communication quality and a communication quality requested by an application program used by the wireless terminal apparatus.

A quality prediction engine according to an aspect of the present invention is a quality prediction engine that predicts a quality related to communication performed by a wireless terminal apparatus, and the quality prediction engine includes: an acquisition unit that acquires information about a plurality of wireless base stations connectable to the wireless terminal apparatus, model information of the wireless terminal apparatus, information about wireless communication environment around the wireless terminal apparatus, and information detected by a sensor mounted on the wireless terminal apparatus from the wireless terminal apparatus; and a notification unit that calculates a predicted value of a communication quality when the wireless terminal apparatus is connected to the plurality of connectable wireless base stations in accordance with a prediction function obtained through deep learning based on the notified information, and to notify the wireless terminal apparatus of the calculated predicted value.

A wireless terminal apparatus according to an aspect of the present invention is a wireless terminal apparatus including: a notification unit that notifies a quality prediction engine of information about a plurality of wireless base stations connectable to the apparatus, model information of the apparatus, information about wireless communication environment around the apparatus, and information detected by a sensor mounted on the apparatus, the quality prediction engine predicting a quality related to communication performed by the apparatus; an acquisition unit that acquires a predicted value of a communication quality in a case of being connected to the plurality of wireless base stations connectable to the apparatus, the predicted value being calculated by using a prediction function obtained through deep learning by the quality prediction engine based on the notified information; and a selection unit that selects a wireless base station to be connected to the apparatus, based on the notified predicted value of the communication quality and a communication quality requested by an application program used by the apparatus.

### Effects of the Invention

According to the present invention, the desired communication quality when the wireless communication apparatus communicates with a wireless base station can be ensured.

### BRIEF DESCRIPTION OF DRAWINGS

FIG. 1 is a diagram illustrating an application example of a wireless communication system according to an embodiment of the present invention.

FIG. 2 is a diagram illustrating an example of processing performed by the wireless communication system according to the embodiment of the present invention.

FIG. 3 is a diagram illustrating an example of the form of selecting a wireless base station to be wirelessly communicated.

FIG. 4 is a graph showing an example of measured values, desired values, and predicted values of throughput between a wireless terminal and a wireless base station.

FIG. 5 is a diagram illustrating a functional configuration example of the wireless terminal of the wireless communication system according to the embodiment of the present invention.

FIG. 6 is a diagram illustrating a functional configuration example of the wireless base station of the wireless communication system according to the embodiment of the present invention.

FIG. 7 is a diagram illustrating a functional configuration example of a quality prediction engine according to the embodiment of the present invention.

FIG. 8 is a flowchart illustrating an example of processing procedures of the wireless communication system according to the embodiment of the present invention.

FIG. 9 is a diagram illustrating an example of a sequence of processing procedures related to collection and accumulation of data (dats) from a wireless terminal.

FIG. 10 is a flowchart illustrating an example of processing procedures related to learning of a prediction function.

FIG. 11 is a diagram illustrating an example of a sequence of processing procedures related to provision of a predicting function to a wireless terminal.

FIG. 12 is a diagram illustrating an example of tuning of configuration parameters of a prediction function.

FIG. 13 is a block diagram illustrating an example of a hardware configuration of a quality prediction engine of the wireless communication system according to the embodiment of the present invention.

### DESCRIPTION OF EMBODIMENTS

Hereinafter, an embodiment according to the present invention will be described with reference to the drawings.

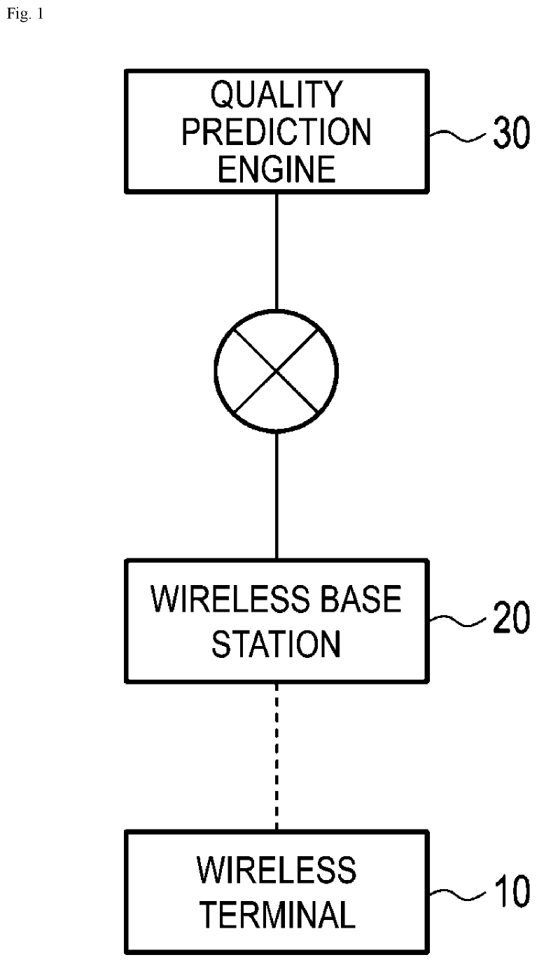

FIG. 1 is a diagram illustrating an application example of a wireless communication system according to an embodiment of the present invention.

As illustrated in FIG. 1, the wireless communication system according to the embodiment of the present invention includes a wireless terminal 10, a wireless base station 20, and a quality prediction engine 30. Details of each unit will be described below.

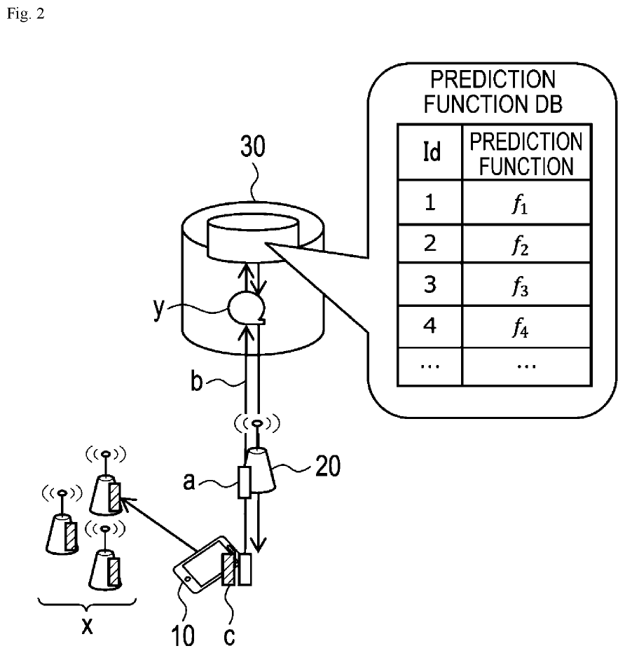

FIG. 2 is a diagram illustrating an example of processing performed by the wireless communication system according to the embodiment of the present invention.

In the wireless communication system according to the embodiment of the present invention, the quality prediction engine 30 notifies a wireless terminal apparatus (hereinafter referred to as a “wireless terminal”) 10 of a predicted value of a wireless communication quality between the wireless terminal 10 and each wireless base station (see x in FIG. 2) located around the wireless terminal 10 and connectable to the wireless terminal 10, and thus the wireless terminal 10 can select a wireless base station and perform optimal control of routing settings for each application.

The wireless terminal 10 notifies the quality prediction engine of terminal model information, time information, surrounding wireless communication environment information (may be referred to as “wireless environment information”), sensor information, and the like as information of the wireless terminal 10, in addition to a list of connectable wireless base stations located around the wireless terminal 10. The surrounding wireless communication environment information is, for example, a list indicating identification information of a wireless base station, a received power of the wireless base station, and the like. The sensor information is, for example, sensor values obtained by an acceleration sensor, an orientation sensor, and the like.

The quality of a communication path varies depending on a fluctuation over time in interference traffic of other wireless terminals in a high-density environment of wireless base stations, the number of interference signals, and the intensity of the signals, due to a prediction function using prediction technology such as deep learning. In response to a notification of various information described above, the quality prediction engine 30 outputs a predicted value of a communication quality considering the quality of the communication path and notifies the wireless terminal 10 of the predicted value.

The following processes of (1) to (3) are repeatedly performed between the quality prediction engine 30 and the wireless terminal 10.

(1) Wireless Quality Prediction Request to Quality Prediction Engine 30 by Wireless Terminal 10 (see “a” in FIG. 2)

In (1), the wireless terminal 10 notifies the quality prediction engine 30 of, as arguments, a communication quality prediction request signal through a line for a control signal using “a list of surrounding connectable wireless base stations, terminal model information, time information, surrounding wireless communication environment information, and sensor information”.

(2) Response of Wireless Quality Prediction Results to Wireless Terminal 10 by Quality Prediction Engine 30 (see “b” in FIG. 2)

In (2), the quality prediction engine 30 manages a prediction function learned from a large data group of “the arguments mentioned above in (1) and measured communication quality values” accumulated in the past, in a prediction function database (DB) in advance for each wireless base station of an area. Examples of the measured communication quality values include throughput, a latency, a jitter, a packet loss, and the like. In the prediction function DB, an ID (=1, 2, 3, 4, . . . ) of each wireless base station and a prediction function fᵢ (i=1, 2, 3, 4, . . . ) of a communication quality when a wireless terminal performs communication through each wireless base station are managed in association with each other.

When the quality prediction engine 30 receives the above-mentioned wireless quality prediction request of the above (1) according to an internal quality predicting function (y in FIG. 2), by the quality predicting function, the quality prediction engine 30 reads a prediction function corresponding to “a list of surrounding connectable wireless base stations” of all arguments from the prediction function DB, outputs a predicted value of a communication quality using the prediction function, and returns the predicted value to the wireless terminal 10.

For example, when IDs of the surrounding wireless base stations connectable to the wireless terminal 10 that is the source of the communication quality prediction request, are 1, 2, and 3, prediction functions to be read are f₁, f₂, and f₃ illustrated in FIG. 2.

(3) Selection of Wireless Base Station by Wireless Terminal 10 and Routing Settings for Each Application (see “c” in FIG. 2)

In (3), the wireless terminal 10 selects a wireless base station to be connected and sets routing for each application, with reference to quality predicted values of the surrounding wireless base stations notified from the quality prediction engine 30 and a communication quality requested from an application being used by the wireless terminal 10.

Note that, regarding time information among the pieces of information notified from the wireless terminal 10 to the quality prediction engine 30, the time at which the quality prediction engine 30 has received a wireless quality prediction request from the wireless terminal 10 may be used instead of information notified from the wireless terminal 10.

In the present embodiment, a desired communication quality of a wireless application can be secured in a high-density environment of wireless base stations.

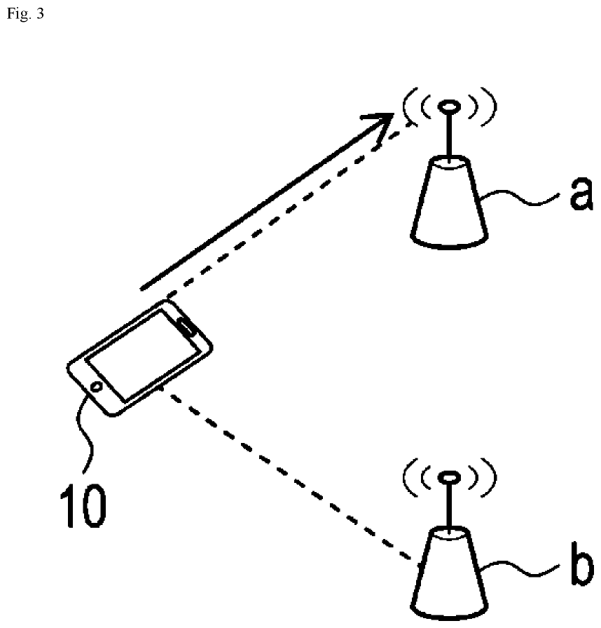

FIG. 3 is a diagram illustrating an example of the form of selection of a wireless base station to be wirelessly communicated.

The example illustrated in FIG. 3 shows that the wireless terminal 10 selects a wireless base station “a” having a high communication quality indicated by a predicted value as a communication destination, based on a predicted value of a communication quality when communication with the wireless base station “a” has been performed, and a predicted value of a communication quality when communication with a wireless base station “b” has not been performed.

In the present embodiment, even in an environment in which the quality of wireless communication changes complicatedly due to an increase in the density of wireless base stations, a predicted value of a wireless communication quality between a wireless terminal and the wireless base stations positioned around the terminal and connectable to the wireless terminal is monitored at all times, the predicted value being acquired from the quality prediction engine 30. Thus, as illustrated in FIG. 3, the wireless terminal 10 can be continuously connected to other wireless base stations that satisfy a desired communication quality at all times.

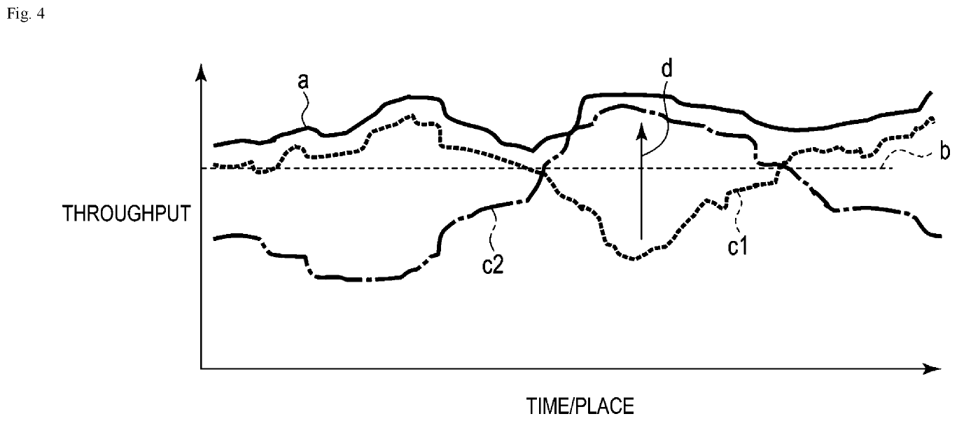

FIG. 4 is a diagram illustrating an example of measured values, desired values, and predicted values of throughput between a wireless terminal and a wireless base station. FIG. 4 illustrates a measured value “a” of a throughput that changes depending on a time or a place, a desired value of a throughput, a predicted value “c1” of throughput when the wireless terminal 10 is communicatively connected to a first wireless base station, and a predicted value “c2” of a throughput when the wireless terminal 10 is communicatively connected to a second wireless base station.

Here, in a situation where the predicted value cl out of the predicted values c1 and c2 is equal to or greater than a desired value “b”, the wireless terminal 10 can be communicatively connected to the first wireless base station to satisfy a desired communication quality. Similarly, in a situation where the predicted value c2 out of the predicted values c1 and c2 is equal to or greater than the desired value “b”, the wireless terminals 10 can be communicatively connected to the second wireless base station to satisfy a desired communication quality and avoid congestion (“d” in FIG. 4).

In this manner, the wireless terminal 10 can be continuously connected to other wireless base stations that satisfy a desired communication quality at all times as described above by selecting a wireless base station to be connected, in accordance with magnitude of predicted values.

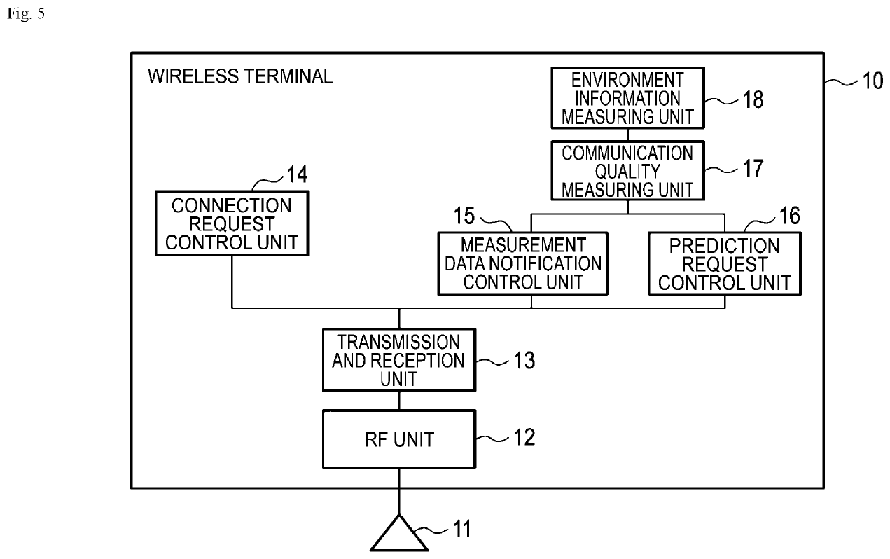

FIG. 5 is a diagram illustrating a functional configuration example of a wireless terminal of the wireless communication system according to the embodiment of the present invention.

As illustrated in FIG. 5, an antenna unit 11 is attached to the wireless terminal 10, and the wireless terminal 10 includes a radio frequency (RF) unit 12, a transmission and reception unit 13, a connection request control unit 14, a measurement data notification control unit 15, a prediction request control unit 16, a communication quality measuring unit 17, and an environment information measuring unit. The antenna unit 11, the RF unit 12, and the transmission and reception unit 13 are used for transmission and reception with respect to the wireless base station 20. Operations of other units will be described below.

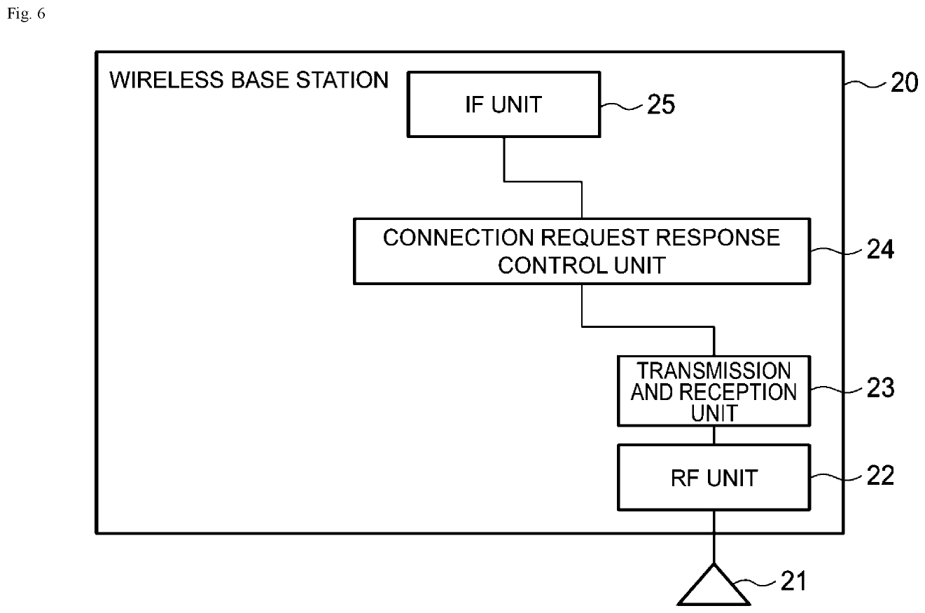

FIG. 6 is a diagram illustrating a functional configuration example of the wireless base station of the wireless communication system according to the embodiment of the present invention.

As illustrated in FIG. 6, an antenna unit 21 is attached to the wireless base station 20, and the wireless base station 20 includes an RF unit 22, a transmission and reception unit 23, a connection request response control unit 24, and an interface (IF) unit 25.

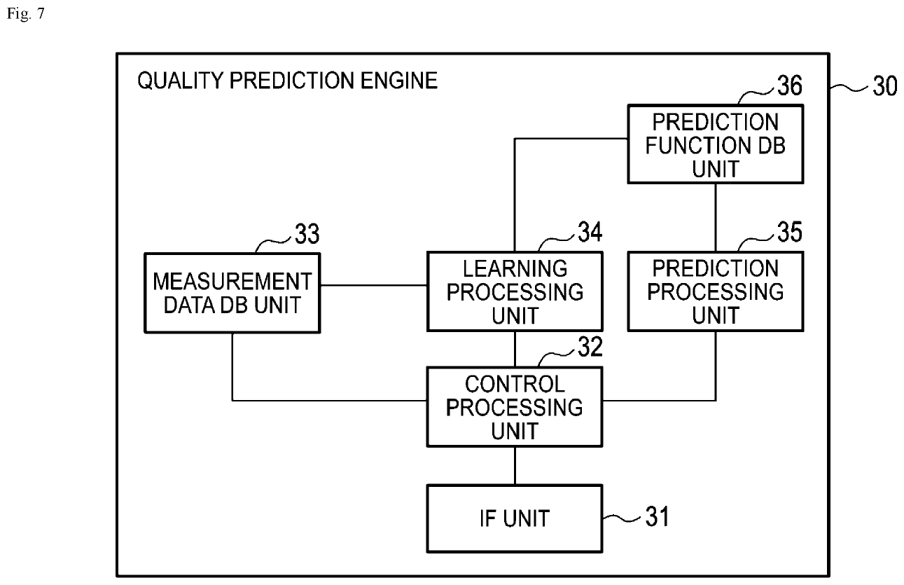

FIG. 7 is a diagram illustrating a functional configuration example of the quality prediction engine according to the embodiment of the present invention.

As illustrated in FIG. 7, the quality prediction engine 30 includes an IF unit 31, a control processing unit 32, a measurement data DB unit 33, a learning processing unit 34, a prediction processing unit 35, and a prediction function DB unit 36. The control processing unit 32 performs operations of the IF unit 31, the measurement data DB unit 33, the learning processing unit 34, and the prediction processing unit 35. Operations of other units will be described below.

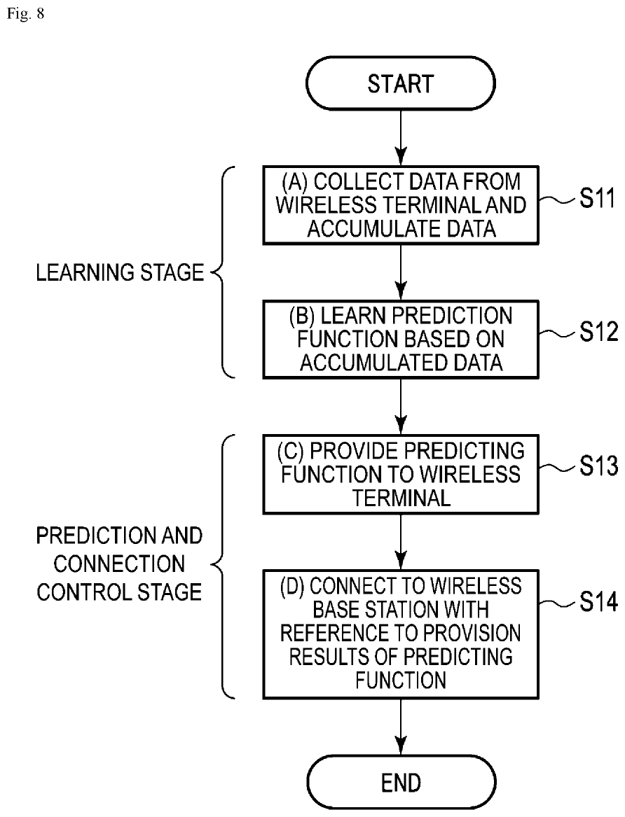

FIG. 8 is a flowchart illustrating an example of processing procedures of the wireless communication system according to the embodiment of the present invention.

The processing procedures of the wireless communication system are divided into a learning stage and a prediction and connection control stage.

In the learning stage, as processing (A), the quality prediction engine 30 collects data from the wireless terminal 10 and accumulates the data (S11).

Next, as processing (B), the quality prediction engine 30 learns a prediction function of a communication quality based on the accumulated data (S12).

Next, in the prediction and connection control stage, as processing (C), the quality prediction engine 30 provides a predicting function to the wireless terminal 10 (S13).

Next, as processing (D), the connection request control unit 14 of the wireless terminal 10 selects a wireless base station 20 having a high predicted value of a communication quality, for example, the highest predicted value with reference to a result of the provision of the predicting function, and transmits a connection request to the wireless base station 20 through the transmission and reception unit 13, the RF unit 12, and the antenna unit 11 (S14).

The transmitted connection request is received through the antenna unit 21, the RF unit 22, and the transmission and reception unit 23 of the wireless base station 20, and the connection request response control unit 24 receives the connection request and performs processing for connection to a network through the IF unit 25. Thereby, connection to the network is performed by the wireless terminal 10 which is a request source.

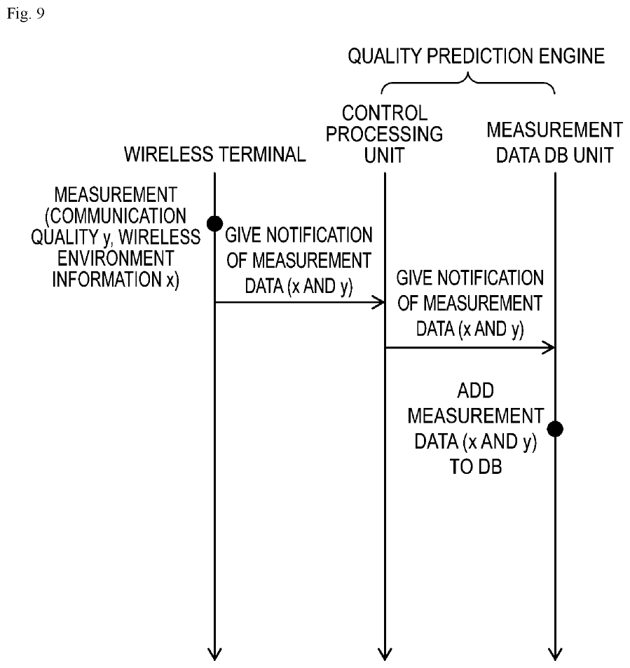

Next, details of the processing related to the collection and accumulation of data from the wireless terminal in S11 described above, will now be described. FIG. 9 is a diagram illustrating an example of a sequence of processing procedures related to the collection and accumulation of data from a wireless terminal.

As S11 in the learning stage described above, first, the measurement data notification control unit 15 of the wireless terminal 10 acquires wireless environment information x related to the wireless terminal 10 and measured by the environment information measuring unit 18 and communication quality information y related to the wireless terminal 10 and measured by the communication quality measuring unit 17.

The measurement data notification control unit 15 notifies the quality prediction engine 30 of the acquired pieces of information as measurement data (x and y) related to the wireless terminal 10 through the transmission and reception unit 13, the RF unit 12, the antenna unit 11, the wireless base station 20, and a network.

The measurement data (x and y) acquired from the wireless terminal 10 is received by the IF unit 31 of the quality prediction engine 30. The control processing unit 32 notifies the measurement data DB unit 33 of the received measurement data (x and y) and accumulates the measurement data in the measurement data DB unit 33.

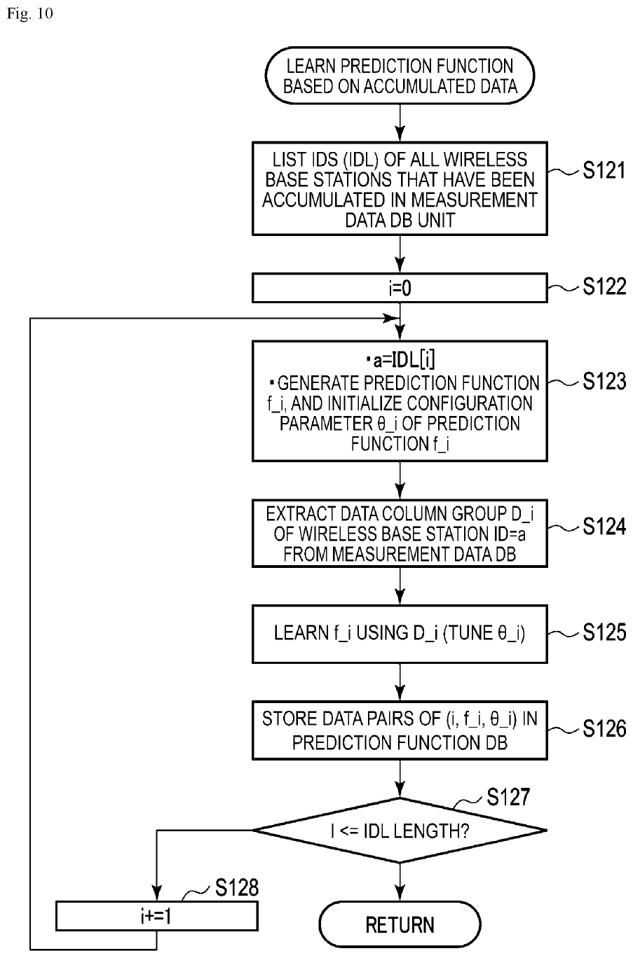

Next, details of processing related to the learning of a prediction function in the above-mentioned S12 will be described. FIG. 10 is a flowchart illustrating an example of processing procedures related to the learning of a prediction function.

The learning processing unit 34 of the quality prediction engine 30 generates an ID list (IDL) in which IDs of all wireless base stations are listed, the ID list having been accumulated in the measurement data DB unit 33 (S121).

The learning processing unit 34 sets a variable i to 0 which is an initial value (S122) and sets “a=IDL [i]”, generates a prediction function f_i, and initializes a configuration parameter θ_i of the prediction function f_i (S123).

The learning processing unit 34 extracts a data column group (D_i) of a wireless base station ID=a from the measurement data DB 33 (S124).

As processing (E), the learning processing unit 34 learns the prediction function f_i using the data column group D_i, that is, tunes the configuration parameter θ_i (S125).

The learning processing unit 34 stores data pairs of prediction functions as (i, f_i, θ_i) in the prediction function DB unit 36 (S126).

When i is less than or equal to an IDL length (Yes in S127), the learning processing unit 34 adds 1 to the variable i (S127) and returns to S123. In the case of “No” in S127, the processing of S12 is terminated.

Next, details of the processing related to the provision of a predicting function to a wireless terminal, which is S13, will be described.

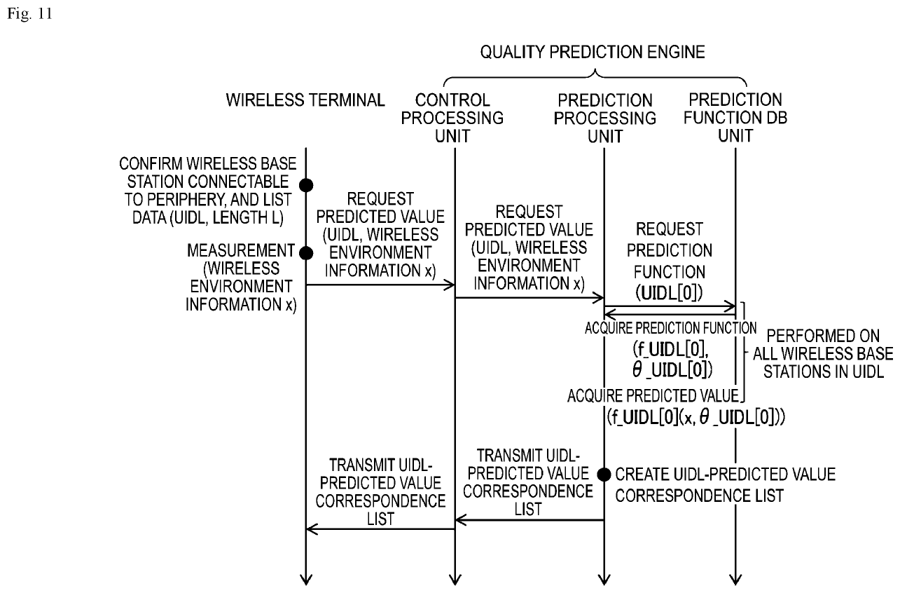

FIG. 11 is a diagram illustrating an example of a sequence of processing procedures related to the provision of a predicting function to a wireless terminal.

The prediction request control unit 16 of the wireless terminal 10 confirms a connectable wireless base station in the vicinity of the wireless terminal 10, and generates listed information (unique identification list (UIDL), a length L).

In addition, the prediction request control unit 16 of the wireless terminal 10 measures wireless environment information x measured by the environment information measuring unit 18, and notifies the quality prediction engine 30 of the information through the transmission and reception unit 13, the RF unit 12, the antenna unit 11, the wireless base station 20, and the network as a predicted value request (UIDL, the wireless environment information x) of a communication quality.

The predicted value request (UIDL, the wireless environment information x) received from the wireless terminal 10 is received by the IF unit 31 of the quality prediction engine 30. The control processing unit 32 notifies the prediction processing unit 35 of the received predicted value request (UIDL, the wireless environment information x).

The prediction processing unit 35 generates a prediction function request (UIDL[0]) based on the notified prediction request, and accesses the prediction function DB unit 36 in response to the prediction function request to acquire prediction functions (f_UIDL[0], θ_UIDL[0]). The acquisition is performed for all wireless base stations indicated by the UIDL.

The prediction processing unit 35 acquires a predicted value (f_UIDL[0] (x, θ_UIDL[0])) of a wireless quality based on the acquired prediction function and the wireless environment information x described above.

The prediction processing unit 35 creates a correspondence list of the UIDL and the predicted value based on the predicted value.

The correspondence list is transmitted to the wireless terminal 10 through the IF unit 31, the network, and the wireless base station 20 by the control processing unit 32.

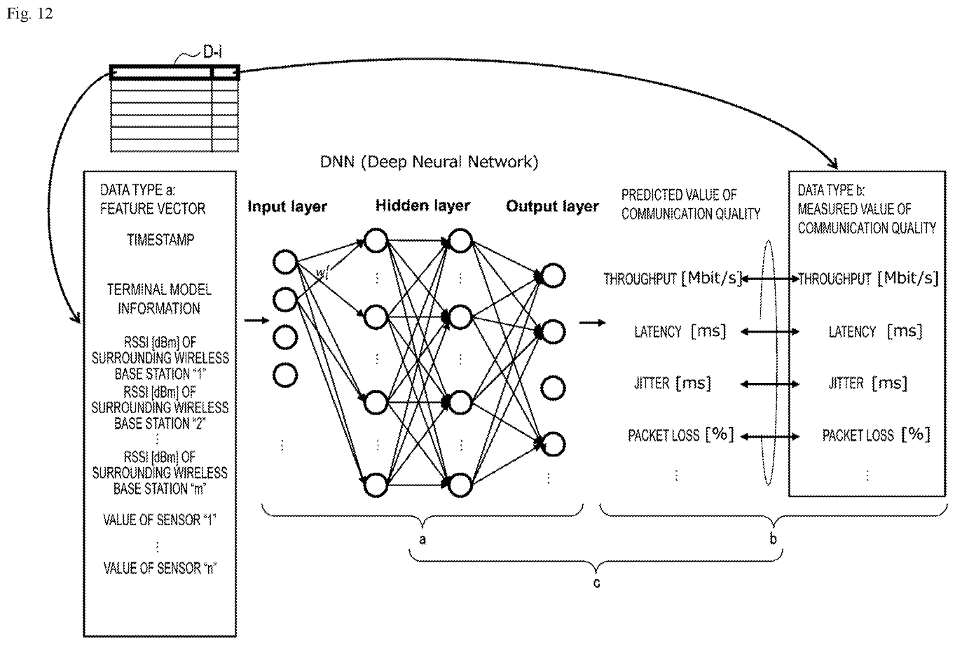

Next, details of the tuning of the configuration parameter of the prediction function in S126 described above will be described. FIG. 12 is a diagram illustrating an example of the tuning of a configuration parameter of a prediction function.

As illustrated in FIG. 12, a deep neural network (DNN) used by the prediction processing unit 35 of the quality prediction engine 30 includes an Input layer, a Hidden layer, and an Output layer. The Input layer, the Hidden layers, and the Output layer correspond to the configuration parameter θ_i of a prediction function. A configuration parameter group of the DNN corresponds to weights and biases between all neurons and layers.

A feature vector, which is a data type “a” being a first data type in the data column group D_i extracted in S125, is input to the Input layer.

The feature vector includes (1) a time stamp, (2) terminal model information, (3) receiving signal strength indicators (RSSI) (reception intensities) [dBm] of m surrounding wireless base stations “1”, “2”, . . . “m”, and (4) sensor values detected by n sensors related to the wireless terminal 10 which is the source of a prediction request.

A predicted value of a communication quality is output from the Output layer. The predicted value includes the predicted value of throughput, the predicted value of latency, the predicted value of jitter, and the predicted value of a packet loss.

In S126, these predicted values are compared for each type between the measured values of communication quality, the type being the first data type in the extracted data column group D_i. The measured values of the communication quality include the measured value of throughput, the measured value of latency, the measured value of jitter, and the measured value of a packet loss.

Errors between all predicted values and measured values related to the data column group D_i are calculated through the comparison. From the calculation results, the learning processing unit 34 defines a loss function, for example, a square loss, and tunes the configuration parameter θ_i to minimize the value of the loss function. Thereby, the learning of the prediction function is performed.

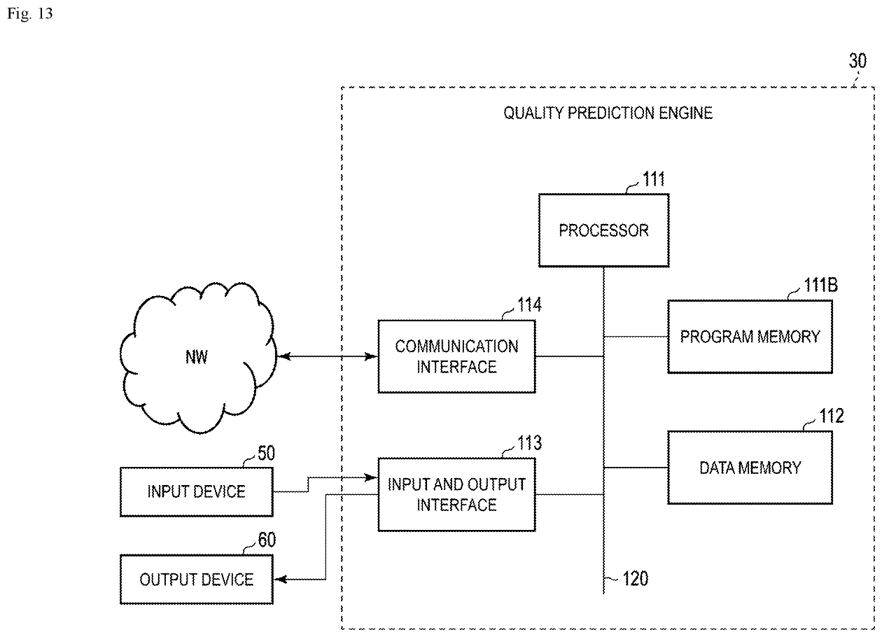

FIG. 13 is a block diagram illustrating an example of a hardware configuration of the quality prediction engine of the wireless communication system according to the embodiment of the present invention.

In the example illustrated in FIG. 13, the quality prediction engine 30 according to the embodiment described above is provided with, for example, a server computer or a personal computer and includes a hardware processor 111A such as a CPU. In addition, a program memory 111B, a data memory 112, an input and output interface 113, and a communication interface 114 are connected to the hardware processor 111A via a bus 120. The same may apply to the wireless terminal 10 and the wireless base station 20.

The communication interface 114 includes, for example, one or more wireless communication interface units to allow transmission and reception of information to and from a communication network NW. As the wireless interface, for example, an interface adopting a small power wireless data communication standard such as a wireless local area network (LAN) is used.

An input device 50 and an output device 60 for an operator may be connected to the input and output interface 113.

For the program memory 111B, a non-volatile memory that always allows writing and reading, such as a Hard Disk Drive (HDD) or a Solid State Drive (SSD) and a non-volatile memory such as a Read Only Memory (ROM), for example, are used in combination as a non-transitory tangible storage medium, and a program necessary to execute various kinds of control processing according to the embodiment is stored therein.

For the data memory 112, for example, the above-mentioned non-volatile memory and a volatile memory such as a Random Access Memory (RAM) are used in combination as a tangible recording medium, and the data memory 112 is used to store various kinds of data acquired and created in the process of performing various kinds of processing.

The quality prediction engine 30 according to the embodiment of the present invention can be formed as a data processing device including the IF unit 31, the control processing unit 32, the measurement data DB unit 33, the learning processing unit 34, the prediction processing unit 35, and the prediction function DB unit 36 illustrated in FIG. 4 as processing functional units based on software. The same applies to each unit in the wireless terminal 10 and each unit in the wireless base station 20.

The measurement data DB unit 33 and the prediction function DB unit 36 can be formed by using the data memory 112 illustrated in FIG. 13. However, these regions do not have configurations that are essential in the quality prediction engine 30 and may be regions provided in a storage device such as an external storage medium such as a universal serial bus (USB) memory or a database server disposed in a cloud.

All of the functional processing units in the units of the quality prediction engine 30, the wireless terminal 10, and the wireless base station 20 can be implemented by causing the above-mentioned hardware processor 111A to read and execute the program stored in the program memory 111B. Note that some or all of the processing functional units may be implemented by other various methods including an integrated circuit such as an application specific integrated circuit (ASIC) or a field-programmable gate array (FPGA).

A method described in each embodiment can be stored in a recording medium such as, for example, a magnetic disk (a Floppy (registered trademark) disk, a hard disk, or the like), an optical disc (a CD-ROM, a DVD, an MO, or the like), a semiconductor memory (a ROM, a RAM, a flash memory, or the like), or the like, and can be transferred and distributed by a communication medium, as a program (a software means) that can be executed by a computing device (computer). Note that the program stored on the medium side includes a setting program for providing the computing device with a software means (including not only an execution program but also a table and a data structure) to be executed by the computing device. The computing device in which the present apparatus is implemented executes the above-mentioned processing by reading the program recorded in the recording medium, constructing the software means using the setting program in some cases, and causing the software means to control operations. Note that the recording medium mentioned in the present specification is not limited to a recording medium for distribution but includes a storage medium such as a magnetic disk and a semiconductor memory provided inside the computing device or a device connected via a network.

Note that the present invention is not limited to the above-mentioned embodiment but can be variously modified in the implementation stage without departing from the gist of the present invention. In addition, an appropriate combination of embodiments can also be implemented, in which a combination of their effects can be obtained. Further, the above-mentioned embodiment includes various inventions, which can be designed by combining constituent elements selected from a plurality of constituent elements disclosed herein. For example, a configuration in which some constituent elements are removed from all the constituent elements illustrated in the embodiment can be designed as an invention if the problems can be solved and the effects can be achieved.

### REFERENCE SIGNS LIST

10 Wireless terminal
14 Connection request control unit
15 Measurement data notification control unit
16 Prediction request control unit
17 Communication quality measuring unit
18 Environment information measuring unit
20 Wireless base station
30 Quality prediction engine
33 Measurement data DB unit
34 Learning processing unit
35 Prediction processing unit
36 Prediction function DB unit

1. A wireless communication method executed by a wireless terminal apparatus and a quality prediction engine that predicts a quality related to communication performed by the wireless terminal apparatus, the method comprising:
by the wireless terminal apparatus, notifying the quality prediction engine of information about a plurality of wireless base stations connectable to the wireless terminal apparatus, model information of the wireless terminal apparatus, information about wireless communication environment around the wireless terminal apparatus, and information detected by a sensor mounted on the wireless terminal apparatus;
by the quality prediction engine, based on the notified information, calculating a predicted value of a communication quality in a case in which the wireless terminal apparatus is connected to the plurality of connectable wireless base stations in accordance with a prediction function obtained through deep learning, and notifying the wireless terminal apparatus of the calculated predicted value; and
by the wireless terminal apparatus, selecting a wireless base station to be connected to the wireless terminal apparatus based on the notified predicted value of the communication quality and a communication quality requested by an application program used by the wireless terminal apparatus.

2. The wireless communication method according to claim 1, wherein a parameter of the prediction function is learned based on an error between the calculated predicted value of the communication quality and a measured value of the communication quality.

3. The wireless communication method according to claim 1, wherein
the wireless communication environment information includes information of received power of the wireless base station, and
the information detected by the sensor includes information detected by an acceleration sensor and information detected by an orientation sensor.

4. A wireless communication system comprising:
a wireless terminal apparatus; and
a quality prediction engine configured to predict a quality related to communication performed by the wireless terminal apparatus,
wherein the wireless terminal apparatus
notifies the quality prediction engine of information about a plurality of wireless base stations connectable to the wireless terminal apparatus, model information of the wireless terminal apparatus, information about wireless communication environment around the wireless terminal apparatus, and information detected by a sensor mounted on the wireless terminal apparatus,
the quality prediction engine
calculates, based on the notified information, a predicted value of a communication quality in a case in which the wireless terminal apparatus is connected to the plurality of connectable wireless base stations in accordance with a prediction function obtained through deep learning, and notifies the wireless terminal apparatus of the calculated predicted value, and
the wireless terminal apparatus
selects a wireless base station to be connected to the wireless terminal apparatus based on the notified predicted value of the communication quality and a communication quality requested by an application program used by the wireless terminal apparatus.

5. A quality prediction engine that predicts a quality related to communication performed by a wireless terminal apparatus, the quality prediction engine comprising:
a processor; and
a storage medium having computer program instructions stored thereon, when executed by the processor, perform to:
acquire, from the wireless terminal apparatus, information about a plurality of wireless base stations connectable to the wireless terminal apparatus, model information of the wireless terminal apparatus, information about wireless communication environment around the wireless terminal apparatus, and information detected by a sensor mounted on the wireless terminal apparatus; and
calculate, based on the notified information, a predicted value of a communication quality in a case in which the wireless terminal apparatus is connected to the plurality of connectable wireless base stations in accordance with a prediction function obtained through deep learning, and to notify the wireless terminal apparatus of the calculated predicted value.

6. (canceled)

7. A non-transitory computer-readable medium having computer-executable instructions that, upon execution of the instructions by a processor of a computer, cause the computer to function as the quality prediction engine according to claim 5.

8. (canceled)
